(19) United States
(12) Patent Application Publication
(10) Pub. No.: US 2005/0104766 A1
(43) Pub. Date: May 19, 2005

(54) Radar detection zone pattern shaping

(76) Inventor: Brian Bandhauer, Boise, ID (US)

Correspondence Address: PEDERSEN & COMPANY, PLLC, P.O. BOX 2666, BOISE, ID, 83701, US

(21) Appl. No.: 10/714,259

(22) Filed: Nov. 14, 2003

(51) Int. Cl. G01S 7/34

(52) U.S. Cl. 342/91; 342/92; 342/85

(57) ABSTRACT

In an object detection radar system, dynamically adjusting the gain of a radar during its range sweep cycle, either by tuning its transmitter power or its receiver sensitivity or both, allows a variety of detection pattern shapes to be realized. Adjusting the gain is done by using a plurality of different gain corrections, which are applied in the sweep cycle at different ranges. Thus, certain types of detection patterns, as controlled through a setting feature or via a user interface, may be realized by incorporation of an internal microcontroller and associated embedded program into an object detection radar system.

### DESCRIPTION

1. Field of the Invention

The present invention relates generally to techniques for detection zone pattern shaping in object detection radar systems.

2. Related Art

U.S. Pat. No. 6,208,248 B1 by Ross discloses the use of dynamic adjustment of the bias point for a tunnel diode detector as a means of using the detector to identify intruder targets within background clutter.

U.S. Pat. No. 5,901,172 by Fontana discloses the use of a dynamically adjustable attenuator to effectively adjust the operating threshold level of a tunnel diode detector, which has it's bias point set only once at startup. For an overview of Fontana, refer to the following abstract:
“An UWB receiver utilizing a microwave tunnel diode as a single pulse detector for short pulse, impulse, baseband or ultra wideband signals. The tunnel diode detector's bias point is set at system start-up, through an automatic calibration procedure to its highest sensitivity point relative to the desired bit error rate performance (based upon internal noise only) and remains there during the entire reception process. High noise immunity is achieved through the use of a high speed, adaptive dynamic range extension process using a high speed, Gallium Arsenide (GaAs) voltage variable attenuator (VVA) whose instantaneous attenuation level is determined by a periodic sampling of the ambient noise environment. Microprocessor-controlled detector time-gating is performed to switch the tunnel diode detector to the receiver front end circuitry for reception of an incoming UWB pulse, and alternately to ground through a resistor to discharge stored charge on the tunnel diode detector. In a second embodiment, two tunnel diode detectors are utilized in parallel, one biased for data detection and the other biased for noise detection, such that data detection can be interpreted based on simultaneous comparison to both a data threshold and a noise threshold.”

The advantage discussed by Fontana is that the set-point of the tunnel diode does not have to be continuously updated, thus slowing system response time.

In U.S. Pat. No. 6,031,421, McEwan disclosed a method of creating a controlled gain amplifier with known exponential gain response as a function of time. The few applications discussed in McEvan involve gain adjustment set so as to account for the radiation attenuation as a function of distance in a particular application. It is well known that radiation falls off over distance as the inverse of range raised to some exponent power, depending upon the medium and use (i.e, 1/R for near-field, 1/R² for communications links, 1/R⁴ for radar applications, etc).

While each of the references above provide alternative approaches that have their individual merits, none of the prior art was discovered to resemble the present invention, nor are any of them able to qualify as a pattern shaping device for radar object detection.

### SUMMARY OF THE INVENTION

In an object detection radar system, an invented technique referred to as “pattern shaping” is employed. The invented methods and apparatus comprise dynamically adjusting gain of a radar during its range sweep cycle, either by tuning its receiver sensitivity and/or its transmitter power, to achieve a variety of detection pattern shapes.

The methods and apparatus may control the effective shape of the object detection zone of an object detection radar by utilizing electronically controlled gain variation in the radar receiver circuitry to vary detection zone as a function of range. The electronic gain control may be realized by digital control using digital circuitry, analog circuitry, or a combination thereof. An embedded microprocessor and supporting digital and/or analog circuitry may be used, and the gain variation may be fixed or may be changed via software algorithms.

The electronic gain control may be implemented in the RF receiver portion of the circuitry. This may be done with an electronically controlled attenuator, or an electronic-gain-controlled amplifier, placed in the RF circuitry, for example, or with other forms that will be apparent to one of skill in the art after review of this disclosure.

The electronic gain control may be implemented in the RF-to-IF portion of the receiver circuitry. Various gain control methods may be used, including but not limited to mixer voltage bias or local oscillator power variation, for example, or other forms that will be apparent to one of skill in the art after reviewing this disclosure.

The electronic gain control may be implemented in the signal processor portion of the receiver circuitry. Various gain control methods may be used, including but not limited to digital processing gain control, threshold limiting of the detected signal, or software algorithms written to select varying processed signal strength levels as a function of distance, for example, or other forms that will be apparent to one of skill in the art after reviewing this disclosure.

In an alternative approach, transmit power is modified to change the effective detection zone as a function of distance. Radar range is typically searched in a controlled manner where only one particular distance is actively being viewed at any particular time, and this is commonly known as the “range sweep”. The invention may comprise varying the transmit power in accordance with the range presently being searched, and thereby varying the effective detection zone. Therefore, the object detection zone effective pattern shape may be controlled by electronically-controlled transmitted power variation in the radar transmitter circuitry, to vary the transmitted power as a function of the instantaneous search range, and thus to shape the detection zone as a function of range. Again, digital circuitry, and/or analog circuitry may be used, and an attenuator or amplifier may be used, for example, or other forms that will be apparent to one of skill in the art after reviewing this disclosure.

As an example, an approximately triangular detection pattern can be achieved by steadily increasing the receiver amplifier gain as the radar searches further out in distance, which is similar to using just the 3 dB beamwidth over the whole range. As another example, a wide, bowl-shaped pattern is achieved by maximizing gain very early on as the radar searches close distances. The gain may then be suddenly turned down very low, or to zero when some maximum desired search distance is reached, artificially limiting the maximum useful range. An almost rectangular pattern may be achieved by turning the gain high early, then tapering it down and then back up again as range increases. An hour glass shape may be achieved by turning gain high early, then rapidly tapering down very low, and then tapering back up to maximum again at maximum distance. Such a pattern might be useful for desensistizing a certain range from the radar.

Other detection zone shapes may be achieved, as the preferred methods and apparatus include using more than one correction “factor” or “equation”, with different of said correction factors or equations being applied at different ranges in the range sweep.

### BRIEF DESCRIPTION OF THE DRAWINGS

FIG. 1A is a circuit block diagram of one embodiment of an object detect radar, showing one embodiment of pattern shaping gain adjustment in the RF section of the receiver circuitry.

FIG. 1B is a circuit block diagram of one embodiment of object detect radar, showing one embodiment of pattern shaping gain adjustment in the RF-to-IF down-conversion section of the receiver circuitry.

FIG. 1C is a circuit block diagram of one embodiment of object detect radar, showing one embodiment of pattern shaping gain adjustment in the transmitter section of the circuitry.

FIG. 2 is a circuit block diagram of a preferred method for pattern shaping in the present invention showing pattern shaping gain adjustment in the intermediate frequency (IF) section of the receiver circuitry.

FIG. 3 is a schematic diagram of a microprocessor controlled step attenuator of a preferred method for pattern shaping.

FIG. 4 is a polar plot of a typical antenna power pattern.

FIGS. 5A, 5B and 5C each represent a plot of a radar detection coverage area corresponding to one fixed range-dependent gain correction using the antenna of FIG. 4.

FIGS. 6A, 6B and 6C each represent a plot of radar detection pattern using embodiments of the invented gain correction methods or apparatus to shape three distinct coverage areas using the antenna of FIG. 4.

### DETAILED DESCRIPTION OF THE INVENTION

Traditionally, the active detection zone of a radar object detection device has been defined by the radiation patterns of the antennas used. To a large extent, this must be true since the basic ability of the antenna to transmit and receive radiation presents a fundamental limitation in what can be “seen” by the radar. Consequently, a large amount of effort has gone into specialized antenna design, including beam steering techniques and adaptive array technology.

At relatively close ranges, it is possible to use a different approach. The receiver signal path gain or processing gain may be adjusted to limit or broaden the active area of detection. It is also possible to accomplish this by varying the transmitted power over time in accordance with the range being looked at by the receiver.

Conventionally, an antenna's beamwidth is defined by the half-power (3 dB) points where the power transmitted or received is down ½ from its maximum direction. Little attention is paid to the 6 dB (¼ power), 10 dB (1/10^{th} power), etc., beamwidths of the antenna, other than perhaps from a perspective of unintentional radiation consequences. If sufficient dynamic range exists in the radar, these lower-power portions of the antenna might also be used. At the furthest distances where the radar operates at its maximum limits, it is the 3 dB bandwidth (or even less) that defines the active zone where the radar detects objects because maximum power is needed to achieve object detection. But closer to the radar there is sufficient power available to “see” wider into the beamwidth because the free-space radiation loss is much lower (returned radiation falls off as 1/range\hat{ }4 in a radar), and the radar gain components may be increased to further enhance the capability to use the weaker portions of the antenna beam. Alternatively, it is also possible to turn down the radar's gain components so that only the stronger, narrower portions of the beam are useful for detection.

To affect the desired pattern shaping function in a typical radar object detection device, a number of possible controls may be implemented that provide satisfactory levels of performance. Different techniques and a preferred method to implement pattern shaping are described herein.

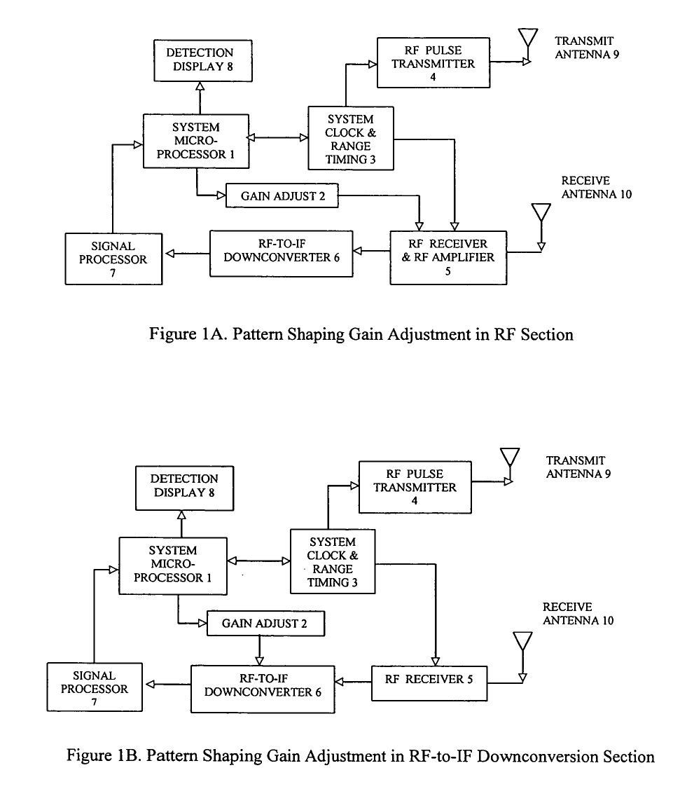

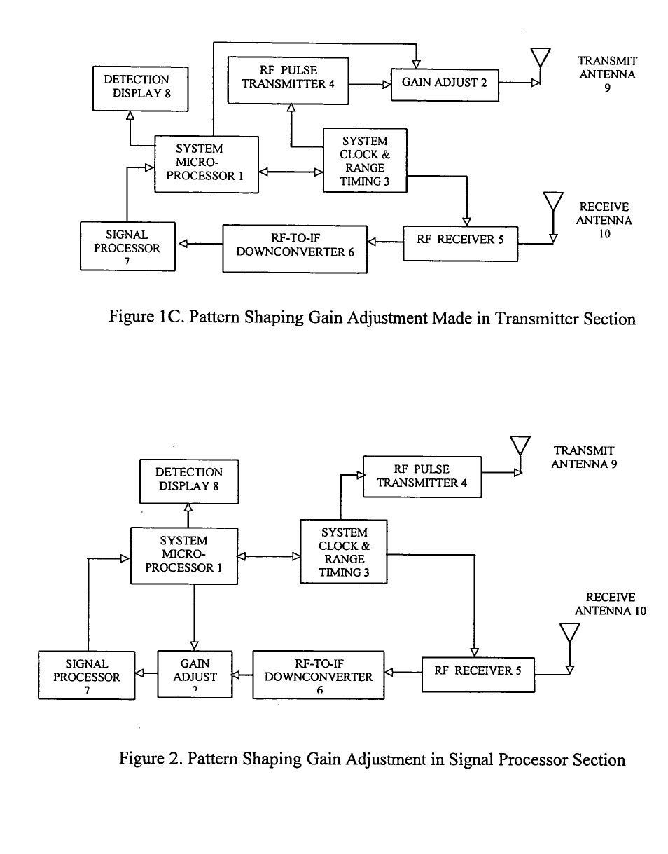

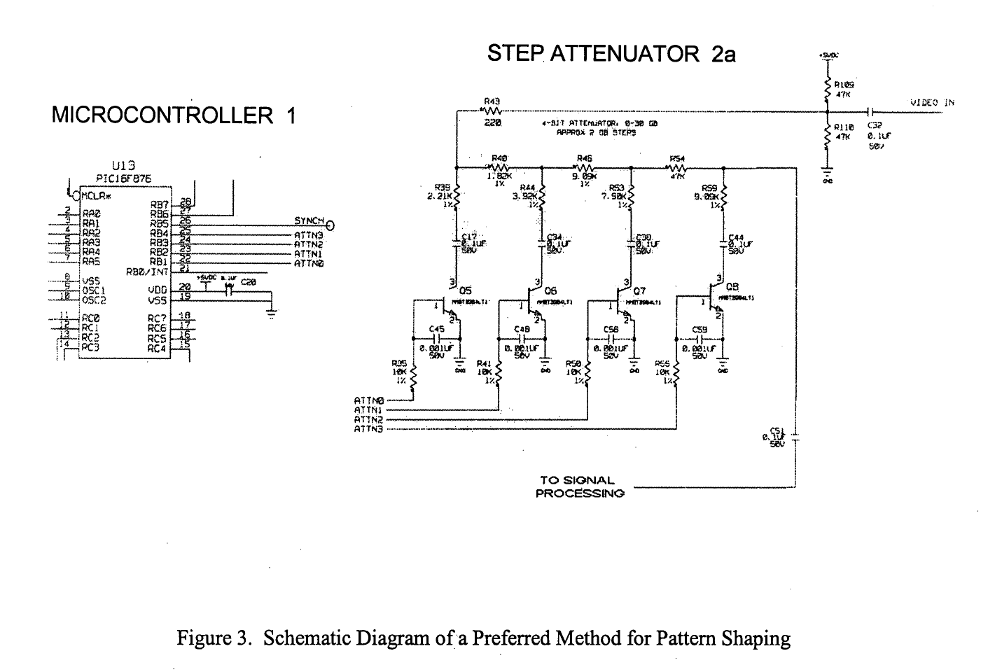

FIG. 1A through 1C and FIG. 2 are circuit block diagrams of typical object detect radars circuits, with pattern shaping gain adjustments effected differently in each respective figure's circuitry. In each of these schematic block diagrams, System Microprocessor 1 is the primary component in facilitating control of the radar system, including the control of each representative pattern shaping technique illustrated in these circuit block diagrams. The control of Gain Adjust Circuit 2 is accomplished by an embedded program executed on microcontroller 1 in the alternate embodiments depicted in FIGS. 1A through 1C and in FIG. 2.

Also present in each of FIGS. 1A through 1C are the following distinct circuits typical of object detection radars: System Clock and Range Timing circuit 3, RF Pulse Transmitter circuit 4, RF Receiver and RF Amplifier circuit 5, RF-to-IF Downconverter circuit 6, Signal Processor circuit 7, Detection Display circuit 8, and Transmit and Receive Antennae 9 and 10.

With regard to the circuits and antennae numbered 3 through 10 in FIGS. 1A through 1C, these individual circuits presently exist and are available in the public domain. Design techniques and components for each of the circuit sections are readily available to enable those skilled in the art to construct these radar devices once this description and the drawings are viewed. The method of pattern shaping described herein may be combined with state of the art object detection radar circuit elements, to implement object detection using a radar. The hardware supporting the algorithms can take many forms.

All ranging radars employ some technique for deducing the range. In pulsed-emission radars, the time delay between pulse emission and echo from a target is measured in some way. Most ranging radars use some version of this technique. These types of radars may use the pattern shaping techniques and algorithms of embodiments of this invention.

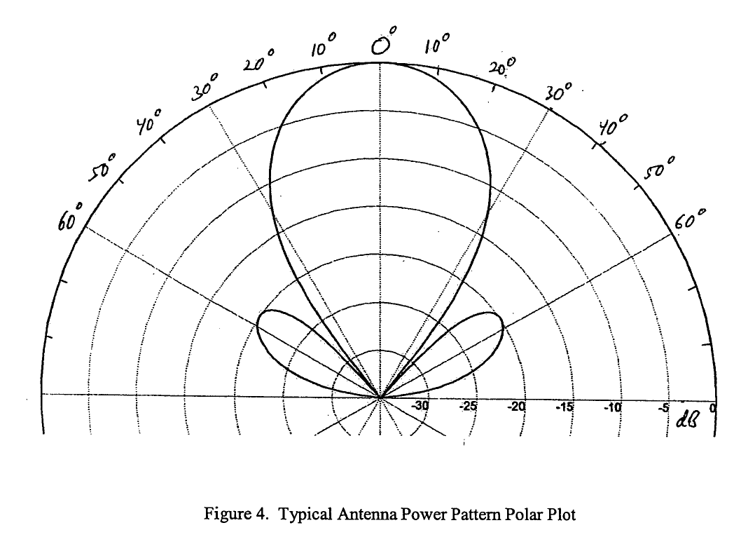

Prior radar technologies have primarily used antenna beam shaping as the method for defining the detection zone coverage area. Once an antenna is designed and built, it's beamwidth is fixed via laws of physics in accordance with it's size, frequency of operation, element array phasing, etc. Therefore the detection pattern is also fixed. FIG. 4 illustrates a representative typical antenna beamwidth pattern in the horizontal (azimuth) plane.

FIG. 4 shows the relative signal strength as a function of angle with respect to antenna beam center. In FIG. 4, the ½-power (3 dB) angular span is about 34 degrees (˜17 degrees to each side of center), and the 1/4-power (6 dB) angular span is about 44 degrees, etc. When a radar target is far away from the radar, it is typical that the radar can only detect the object while it is within its 3 dB beamwidth where the antenna is strongest. This will depend on a number of factors, but is a good rule-of-thumb. Most antennas are specified in terms of their 3-dB beamwidths, but this information does not provide a complete understanding necessary for construction of effective motion and object detection radar devices.

In most ranging radar implementations some form of gain adjustment as a function of search range is used to correct for the variation in reflected power as a function of distance. Typically, this gain adjustment will take the form of a range-squared function over distance because the transmitted energy falls off as 1/range², or as a range-squared-squared (range⁴) function because the echoed energy falls off as 1/range⁴.

The echoed power from a target may be described by the following equation:
P_{received by radar}=P_{Tx}*Gₐₙₜₑₙₙₐ²*σ*λ²/[(4π)³R⁴](Watts)
where
P_{Tx}=Transmit Power (Watts)
Gₐₙₜₑₙₙₐ=Antenna Gain
(Transmit & Receive Antennas are the same in this case)
σ=Radar Cross-Section (square-meters)
λ=Operating Wavelength (meters)
R=Range to Target (meters)

Table 1 below calculates the return power as a function of distance for the following example radar:
P_{Tx}=1 milliWatts
Gₐₙₜₑₙₙₐ=10
σ=1 square-meter (typical radar cross-section for a man)
λ=0.06 meters (5 GHz)
R=5 to 40 meters

Table 1 shows the expected received power levels in dB relative to the 40-meter received power, and power levels when modified using an R-squared gain function and an R⁴ gain function. For example, the R-squared correction at 5 meters is 20 Log (5/40), or −18.1 dB gain at 5 meters relative to gain at 40 meters (max gain). The R⁴ correction at 5 meters is 40 Log (5/40), or −36.2 dB gain at 5 meters relative to 40 meters.

TABLE 1
Radar Received Power Example

| | | | | |
|---|---|---|---|---|
| | Received | P_{Rx} | P_{Rx} | P_{Rx} |
| Range | Pwr | Relative to | Corrected by R² | Corrected by |
| (Meters) | (PicoWatts) | 40 m (dB) | Gain (dB) | R⁴ Gain (dB) |

| | | | | |
|---|---|---|---|---|
| 5 | 290.3 pW | 36.2 dB | 18.1 dB | 0.1 dB |
| 10 | 18.1 pW | 24.1 dB | 12.1 dB | 0.0 dB |
| 15 | 3.6 pW | 17.1 dB | 8.6 dB | 0.1 dB |
| 20 | 1.1 pW | 12.0 dB | 6.0 dB | 0.0 dB |
| 25 | 0.5 pW | 8.5 dB | 4.3 dB | 0.3 dB |
| 30 | 0.2 pW | 4.6 dB | 2.1 dB | −0.4 dB |
| 35 | 0.1 pW | 1.5 dB | 0.4 dB | −0.8 dB |
| 40 | 0.07 pW | 0.0 dB | 0.0 dB | 0.0 dB |

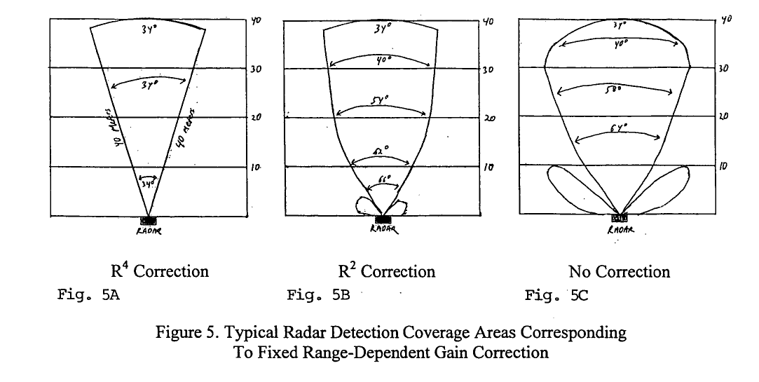

As Table 1 clearly shows, the received power increases very rapidly close to the radar. The implications of this are illustrated in FIGS. 5A-C, where the effective radar detection patterns are plotted for each case above (no range correction, R² correction, and R⁴ correction). It is assumed for these plots that the antenna of FIG. 4 is used, and the 3-dB beamwidth defines the far-distance coverage width at 40 meters. Note that each of the plots (FIGS. 5A-C) use a single correction, that is, either no correction, R², or R⁴.

When R⁴ correction is used, then variation of received power over range is completely compensated. Since the 3-dB beamwidth defines the coverage zone at 40 meters, then this beamwidth defines the coverage at all distances because the return power is made constant over all ranges for the same target.

With R² correction there is variation in the effective beamwidth as the target gets closer. For example, at 40 meters the −3 dB beamwidth still defines the coverage area. At 20 meters, the received power is expected to be about 6 dB stronger for the same target. Therefore, the effective beamwidth would be ˜9 dB (6 dB from Table 1, plus 3 dB, effective at max distance), or about 54 degrees (obtained from FIG. 4, that is ˜27 degrees to either side of center).

Without any gain correction at 20 meters, the received power is expected to be about 12 dB stronger, and a 15 dB beamwidth defines the effective coverage area at 20 meters. It is interesting to note that the antenna side-lobes come into play when an effective beamwidth of greater than 20 dB is used since the side-lobes are only about 20 dB down from the main lobe gain (FIG. 4). This effect is shown approximately in the plots.

In all discovered prior art, the gain correction as a function of distance is uniform and fixed, if discussed at all. Detection zone pattern control has traditionally been accomplished only via narrow beam antennas steered mechanically or electrically to sweep some desired area. This traditional method requires a very high-gain antenna to achieve the narrow beamwidth. Such antennas are required by the laws of physics to be large with respect to the wavelength of operation. Steering the beam adds considerable expense and complexity.

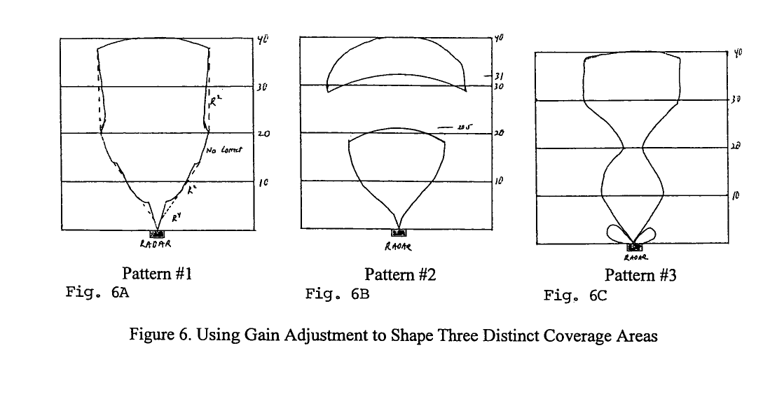

The inventor believes that the gain correction as a function of distance need not be uniform and fixed, and that it is possible to achieve a great deal of detection zone pattern shaping capability by setting and controlling a gain correction profile wherein different correction “factors” or “equations” (herein called “corrections”) are applied at different ranges, rather than a single “uniform” or “fixed” correction. FIGS. 6A-C illustrate three possible detection patterns that can easily be realized via creative control of the gain correction profile. Again these patterns are based upon the antenna of FIG. 4.

The solid line in Pattern #1 (FIG. 6A) would be achieved by piecing together portions of each gain profile in FIG. 6. An algorithm for achieving this would take the following form:

TABLE 2
Pattern 1 Algorithm

| Range | Gain |
|---|---|
| 0-6 Meters | R⁴ Correction |
| 6-14 Meters | R² Correction |
| 14-20 Meters | No Correction (Full Gain) |
| 20-40 Meters | R² Correction |

The dashed lines in Pattern #1 would be achieved by gradually shifting between the gain profiles instead of abruptly stepping.

Patterns #2 and #3 (FIGS. 6B and 6C) purposely cut-off or narrow a region of the detection zone. This can be useful for excluding or desensitizing some region such as a walkway, road, secure passage, etc. Algorithms for Patterns #2 and #3 might take the following forms:

TABLE 3
Pattern 2 Algorithm

| Range | Gain |
|---|---|
| 0-5 Meters | Low Gain to Avoid Side-Lobes |
| 5-20 Meters | Tapered Gain (R^{x} where x is variable) |
| 20.5-31 Meters | No Detection (No Gain or No Tx Power) |
| 31-40 Meters | Full Gain for Widest Coverage |

TABLE 4
Pattern 3 Algorithm

| Range | Gain |
|---|---|
| 0-10 Meters | Approx. R² Gain Profile |
| 10-20 Meters | Rapidly Decreasing Gain |
| 20-30 Meters | Rapidly Increasing Gain |
| 30-40 Meters | Approx. R² Gain Profile |

From these examples it may be seen that embodiments of the invention may comprise adjusting gain, in a range sweep cycle, by a plurality of different corrections. For example, rather than a single correction such as R² or R⁴ for the entire range sweep cycle, the preferred embodiments comprise at least two different corrections. In Pattern #1 (Table 2), R², R⁴, and no adjustment are the plurality of different corrections used. In Pattern #2 (Table 3), low gain, tapered gain, no gain or no transmission, and full gain are the plurality of different corrections used. In Pattern #3 (Table 4), approx. R², rapidly decreasing gain, and rapidly increasing gain are the plurality of different corrections used. The invention may comprise the methods of performing these and/or other corrections, apparatus including microcontroller and associated embedded program adapted to perform any of said invented methods, programming code means, and/or computer product including code for performing the invented methods.

The foregoing has been presented for purposes of illustration and description. It is not intended to be exhaustive or to limit the invention to the precise forms disclosed. Many modifications and variations will be apparent to practitioners skilled in this art. Although this invention has been described above with reference to particular means, materials and embodiments, it is to be understood that the invention is not limited to these disclosed particulars, but extends instead to all equivalents within the scope of the following claims.

1. In an object detection radar device having radar transmitter and radar receiver circuitry, the improvement comprising electronic gain control apparatus adapted to vary gain in the radar receiver circuitry as a function of range to vary the shape of the detection zone of the radar, wherein said apparatus varies said gain by applying a plurality of different corrections to the gain at different ranges.

2. The device of claim 1 where said control apparatus varies gain by digital control using circuitry selected from a group consisting of: digital circuitry, analog circuitry, or a combination thereof.

3. The device of claim 1 where the electronic gain control apparatus comprises an embedded microprocessor and support digital and/or analog circuitry to control said varying of the gain.

4. The device of claim 3, wherein said varying of gain is predetermined and fixed.

5. The device of claim 3, wherein said varying of gain is changeable via software.

6. The device of claim 1 where the electronic gain control is in an RF receiver portion of the circuitry.

7. The device of claim 6, wherein the electronic gain control comprises an electronically controlled attenuator placed in the RF circuitry.

8. The device of claim 6, wherein the electronic gain control comprises an electronic-gain-controlled amplifier used in the RF circuitry.

9. The device of claim 1 where said electronic gain control is in an RF-to-IF portion of the receiver circuitry.

10. The device of claim 9, wherein said electronic gain control comprises mixer voltage bias.

11. The device of claim 9, wherein said electronic gain control comprises local oscillator power variation.

12. The device of claim 1 wherein the electronic gain control is in the signal processor portion of the receiver circuitry.

13. The device of claim 12, wherein the electronic gain control comprises digital processing gain control.

14. The device of claim 12, wherein the electronic gain control comprises threshold limiting of the detected signal.

15. The device of claim 12, wherein the electronic gain control comprises software algorithms written to select varying processed signal strength levels as a function of distance.

16. In an object detection radar device, an electronic control system that controls the effective shape of the object detection zone by utilizing electronically controlled transmitted power variation in the radar transmitter circuitry to vary the transmitted power as a function of the instantaneous search range and thereby effectively shaping the detection zone of the radar as a function of range.

17. The device of claim 16 where the said control system varies power by digital control using circuitry selected from a group consisting of: digital circuitry, analog circuitry, or a combination thereof.

18. The device of claim 16, wherein the electronic control system comprises electronics selected from the group consisting of: an electronically controlled attenuator and an electronic-gain-controlled amplifier.

19. In an object detection radar device having radar transmitter circuitry and radar receiver circuitry, an electronic control apparatus adapted to vary the shape of the detection zone of the radar as a function of distance from the transmitter by dynamically adjusting the gain of a radar during its range sweep cycle by a system comprising tuning of transmitter power.

20. In an object detection radar device having radar transmitter circuitry and radar receiver circuitry, an electronic control apparatus adapted to vary the shape of the detection zone of the radar as a function of distance from the transmitter by dynamically adjusting the gain of a radar during its range sweep cycle by a system comprising tuning of receiver sensitivity.

21. A method of controlling the shape of an object detection zone of an object detection radar system, the method comprising dynamically adjusting gain of the radar during the radar range sweep cycle by applying a plurality of different gain corrections at different ranges, wherein said adjusting is done by a method selected from the group consisting of: tuning of transmitter power, tuning of receiver sensitivity, or a combination thereof.
